(19) United States
(12) Patent Application Publication
(10) Pub. No.: US 2016/0257909 A1
(43) Pub. Date: Sep. 8, 2016

(54) CANDLE

(71) Applicant: Yong-Woo LEE, Gyeonggi-do (KR)

(72) Inventor: Yong-Woo LEE, Seongnam-si (KR)

(21) Appl. No.: 14/386,908

(22) PCT Filed: Jun. 17, 2014
(86) PCT No.: PCT/KR2014/005282

§ 371 Date: Sep. 22, 2014

(30) Foreign Application Priority Data
Jul. 30, 2013 (KR) 10-2013-0090465

(51) Int. Cl. C11C 5/00; F23D 3/16

(52) U.S. Cl. CPC C11C 5/008; C11C 5/002; F23D 3/16

(57) ABSTRACT

A candle that can variously create a color and a scent that a user desires is provided.

The candle includes: a container in which a upper portion is an opening portion; a candle body that is housed within the container and in which a wick is provided; and a decorative combustion material that is filled within the container while enclosing a periphery of the candle body to perform a function of a decoration portion when the candle body does not burn and that exhibits a visual effect and diffuses a scent while burning when the candle body burns.

### CROSS-REFERENCE TO RELATED APPLICATION

This application claims priority to and the benefit of Korean Patent Application No. 10-2013-0090465 filed in the Korean Intellectual Property Office on Jul. 30, 2013, the entire contents of which are incorporated herein by reference.

### BACKGROUND OF THE INVENTION

(a) Field of the Invention

The present invention relates to a candle. More particularly, the present invention relates to a candle that matches a peripheral atmosphere and that can create various colors and scents corresponding to a user's taste.

(b) Description of the Related Art

In general, a candle is produced with a method of burying a wick in a central portion thereof while shaping a combustible solid such as paraffin in a predetermined shape.

Such a candle is variously used for lighting in an emergency situation such as a power failure at a house or a store, for decoration, or for creating a mood at various parties and event halls.

The candle has various shapes of a cylinder, a quadrangle, and a polygon, and when the candle burns, in order to diffuse a scent, a candle in which a material such as aromatic oil is added to a paraffin raw material is produced and used.

As the conventional art of such a candle, Korean Utility Model No. 20-0371932 is disclosed, and the conventional candle diffuses a scent of a spice by a fumigation action by heat when the candle burns by filling a spice along the outside of a wick of the candle.

However, because the conventional candle is formed with a single spice and has a single color, the conventional candle has a drawback that it cannot satisfy various tastes of consumers.

When such a candle is used, while the candle burns, a color and a scent of the candle are diffused, and as the conventional candle is formed with a single color and a single spice, a user cannot help feeling only one color and one scent.

Further, such a candle has a limitation in matching a peripheral atmosphere. For example, a satisfactory result of appropriately matching an atmosphere of spring, summer, fall, and winter or to match both a light location and a dark location cannot be obtained with a candle of a single color.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a candle having advantages of enabling a user to variously create a desired color and scent.

The present invention further provides a candle having advantages of appropriately matching a peripheral atmosphere according to a season or a location.

An exemplary embodiment of the present invention provides a candle including: a container in which a upper portion is an opening portion; a candle body that is housed within the container and in which a wick is provided; and a decorative combustion material that is filled within the container while enclosing a periphery of the candle body to perform a function of a decoration portion when the candle body does not burn and that exhibits a visual effect and diffuses a scent while burning when the candle body burns.

The container may be transparently or translucently formed, and a candle body or at least two candle bodies may be provided within the container.

The container and the candle body may have a cross-sectional shape of at least one selected from a circle, a triangle, a quadrangle, a polygon, a heart shape, a star shape, a moon shape, a sun shape, a person shape, a plant shape, and an animal shape.

The decorative combustion material may include a first decorative combustion material that is formed in a piece form and a second decorative combustion material that is formed in a grain form. The first and second decorative combustion materials may have several colors.

The first and second decorative combustion materials may contain a spice, and the spice may include a natural spice or an artificial spice. The spice may include at least one kind of spice that is selected from chamomile incense, lavender incense, rosemary incense, coriander incense, eucalyptus incense, basil incense, bergamot incense, citronella incense that repels insects and mosquitoes, phytoncide incense, marjoram incense, melissa incense, and botanica spice.

The first decorative combustion material may have at least one shape that is selected from shapes of an animal, a plant, an insect, a fruit, an object, and fish and shellfish.

Another embodiment of the present invention provides a candle including: a container in which a upper portion is an opening portion; a candle body that is received within the container and in which a wick is provided; and a decorative combustion material that is received within the container while enclosing a periphery of the candle body to perform a function of a decoration portion when the candle body does not burn and that exhibits a visual effect and diffuses a scent while burning when the candle body burns, wherein the decorative combustion material is divided into at least two in a length direction, and the respective divided decorative combustion materials contain different spices with different colors.

In a candle according to the present invention, by enabling a user to select a decorative combustion material having various shapes, colors, and scents at the outside of a candle body and by filling the decorative combustion material in the container, the user can obtain various candles corresponding to a user's taste.

When a candle is used, while the decorative combustion material is melted and burned, various colors and scents are mixed and diffused and thus a splendid color sense and scent can be created.

Even when a candle is not used, a decorative combustion material diffuses various scents with various colors, and thus a decoration effect can be obtained.

In this way, when a candle of various colors is produced, a candle of an appropriate color can be selected and used according to a season change or according to a peripheral environment change.

### BRIEF DESCRIPTION OF THE DRAWINGS

FIG. 1 is a perspective view illustrating a candle according to an exemplary embodiment of the present invention.

FIG. 2 is a longitudinal cross-sectional view illustrating the candle of FIG. 1.

FIG. 3 is a perspective view illustrating an example of a container according to an exemplary embodiment of the present invention.

FIG. 4 is a perspective view illustrating another example of a container according to an exemplary embodiment of the present invention.

FIG. 5 is a perspective view illustrating another example of a container according to an exemplary embodiment of the present invention.

FIG. 6 is a perspective view illustrating another example of a container according to an exemplary embodiment of the present invention.

FIG. 7 is a perspective view illustrating an example of a candle body according to an exemplary embodiment of the present invention.

FIG. 8 is a perspective view illustrating another example of a candle body according to an exemplary embodiment of the present invention.

FIG. 9 is a perspective view illustrating another example of a candle body according to an exemplary embodiment of the present invention.

FIG. 10 is a perspective view illustrating another example of a candle body according to an exemplary embodiment of the present invention.

FIG. 11 is a perspective view illustrating another example of a candle body according to an exemplary embodiment of the present invention.

FIG. 12 is a perspective view illustrating another example of a candle body according to an exemplary embodiment of the present invention.

FIG. 13 is a perspective view illustrating a candle body and a decorative combustion material that are provided in various forms in a candle according to an exemplary embodiment of the present invention.

FIG. 14 is a perspective view illustrating candle bodies that are provided in plural in a candle according to an exemplary embodiment of the present invention.

FIG. 15 is a perspective view illustrating a container that is covered with a cover in a candle according to an exemplary embodiment of the present invention.

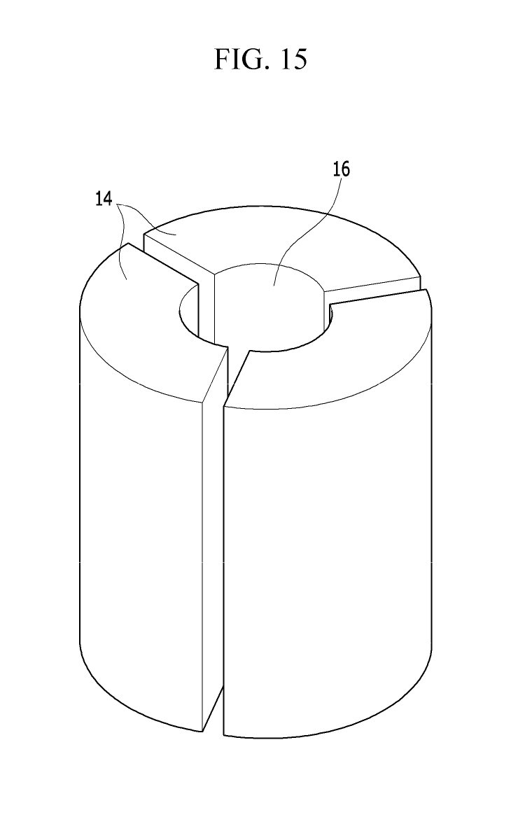

FIG. 16 is a perspective view illustrating a decorative combustion material constituting a candle according to a second exemplary embodiment of the present invention.

FIG. 17 is a perspective view illustrating a candle according to a second exemplary embodiment of the present invention.

### DETAILED DESCRIPTION OF THE EMBODIMENTS

An exemplary embodiment of the present invention will hereinafter be described in detail with reference to the accompanying drawings.

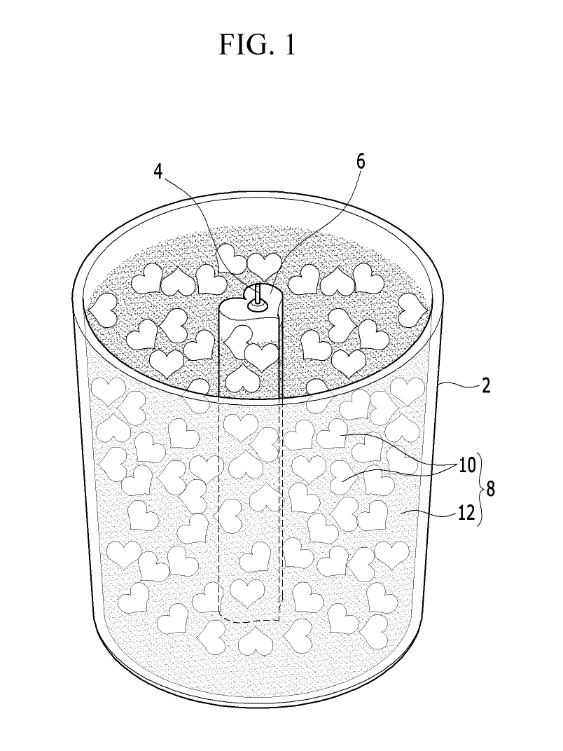

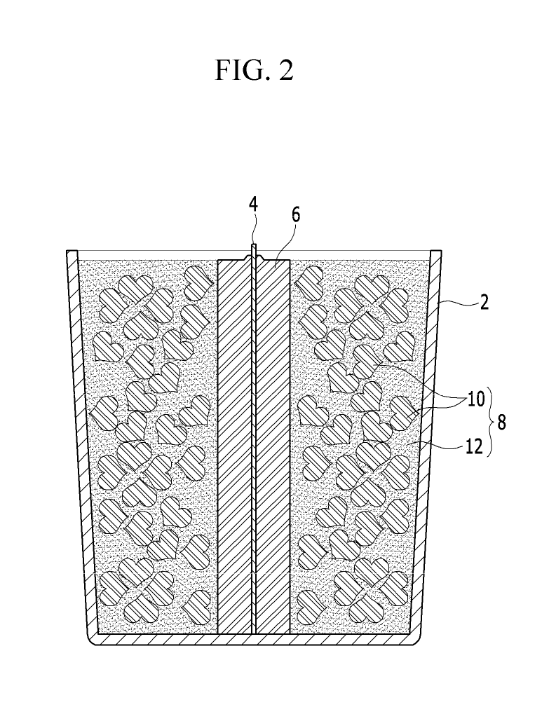

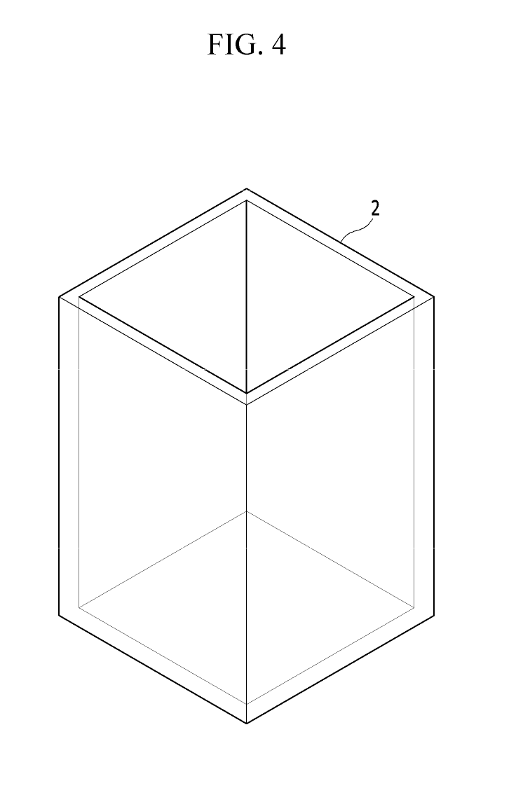

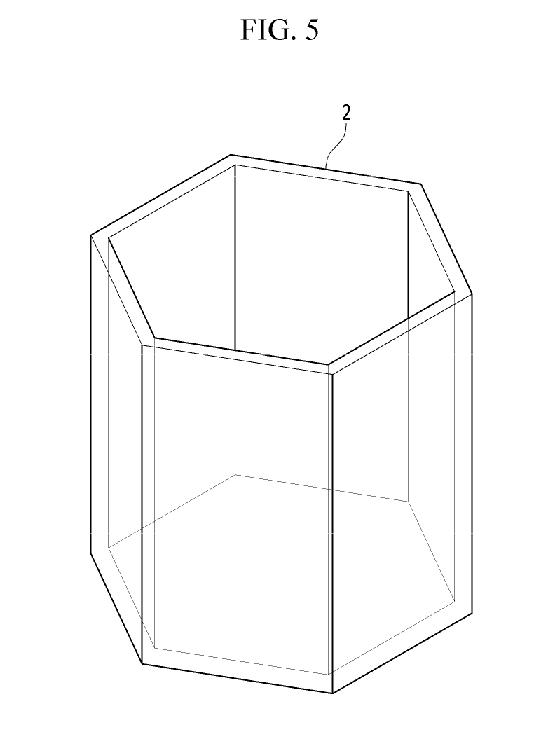

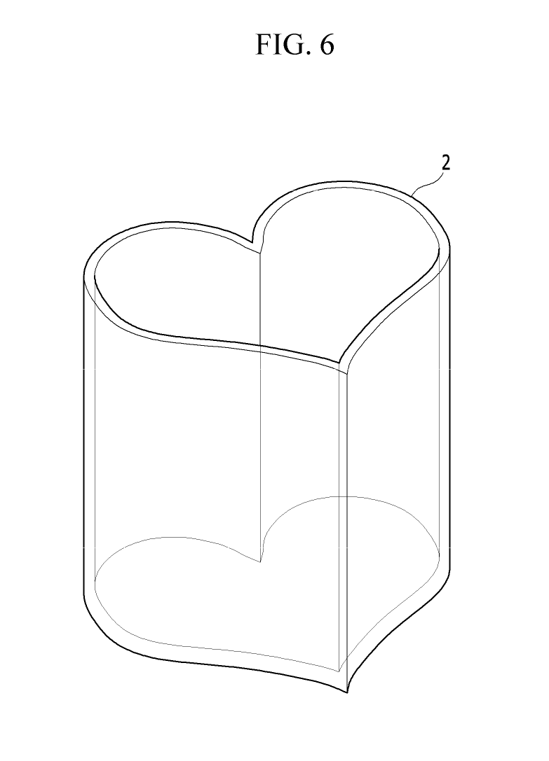

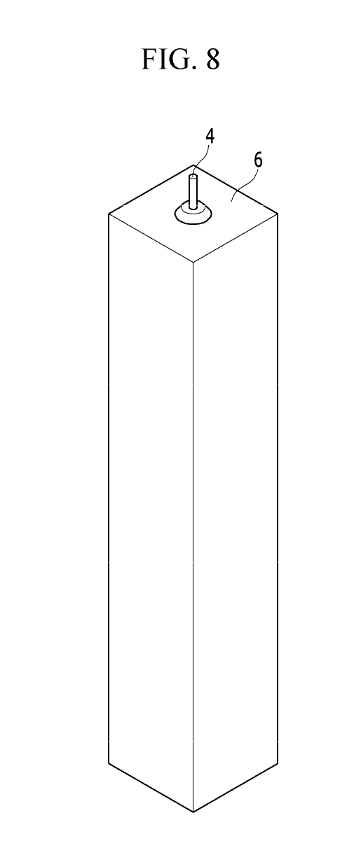

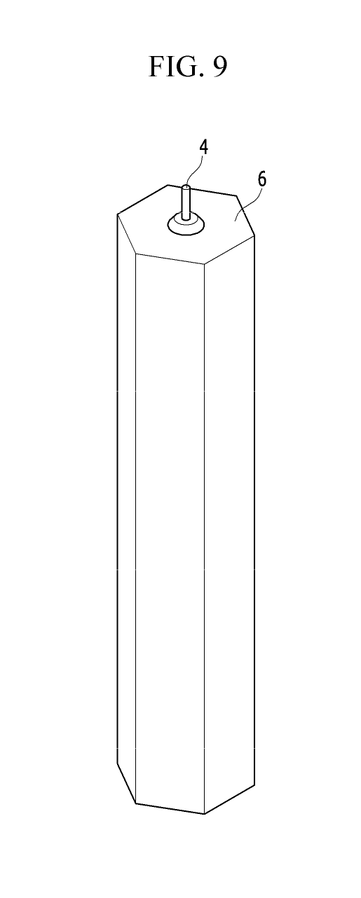

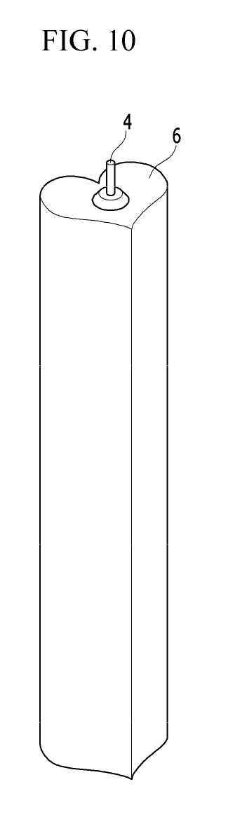

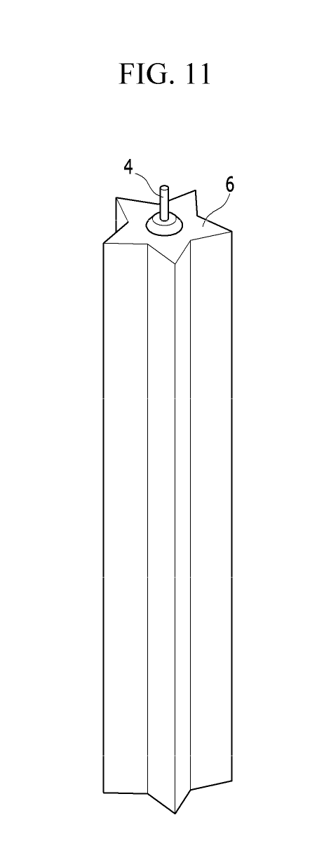

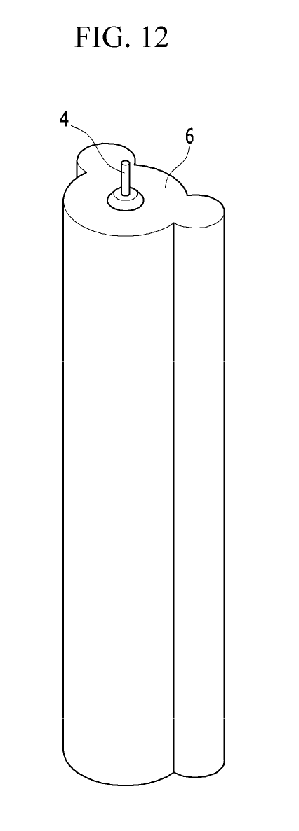

Referring to FIGS. 1 to 14, a candle according to the present exemplary embodiment includes a container 2 in which a upper portion is an opening portion, a candle body 6 that is housed within the container 2 and in which a wick 4 is provided, and a decorative combustion material 8 that is housed within the container 2 while enclosing a periphery of the candle body 6 to perform a function of a decoration portion when the candle body 6 does not burn and that exhibits a visual effect and diffuses a scent while burning when the candle body 6 burns.

The container 2 may be produced in a predetermined shape using a nonflammable material or an incombustible material, and for example, as a nonflammable material, glass and thin film aluminum may be used, and as an incombustible material, incombustible plastic may be used.

Such a container 2 is transparently or translucently formed for a user to view the decorative combustion material 8 that is filled therein from the outside of the container.

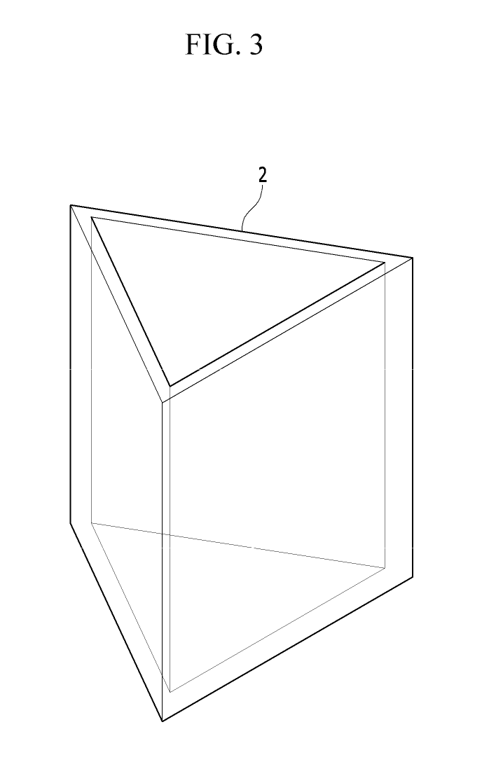

In the present exemplary embodiment, the container 2 has a cross-sectional shape of a circle, but a cross-sectional shape of the container 2 is not limited thereto, and as shown in FIGS. 3 to 6, the container 2 may have a cross-sectional shape of a triangle, a quadrangle, a hexagon, and a heart shape, and the container 2 may have a cross-sectional shape of a polygon, a star shape, a moon shape, a sun shape, a person shape, a plant shape having a stem shape or a petal shape of a plant, and an animal shape having a face or an entire shape of an animal.

In this way, when the container 2 is formed in various shapes, a shape that well matches a location may be selected according to a location at which a candle is to be placed, and the container 2 may perform a function of indoor decoration due to a shape thereof.

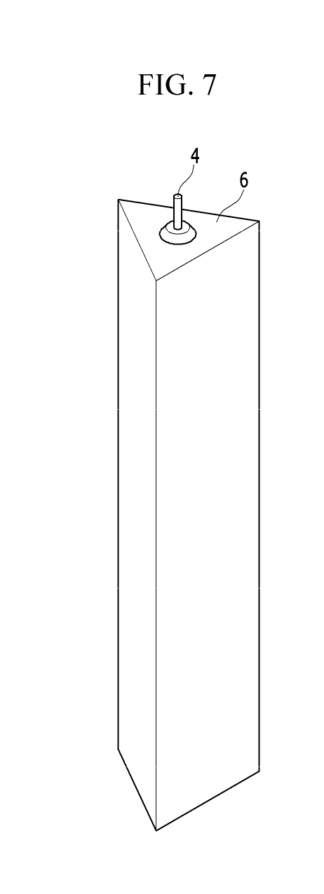

As shown in FIGS. 7 to 12, the candle body 6 may have a cross-sectional shape of a triangle, a quadrangle, a hexagon, a heart shape, a star shape, and an animal shape, and may further have a cross-sectional shape of a polygon, a star shape, a moon shape, a sun shape, a person shape, a plant shape having a stem shape or a petal shape of a plant, and an animal shape having a face or an entire shape of an animal.

In this way, when the candle body 6 is formed in various shapes, the candle may perform a decoration function.

Such a candle body 6 may be shaped in a predetermined shape in which the wick 4 is inserted in a length direction of a central portion using a candle material such as paraffin wax, bean wax, palm wax, and beeswax.

In this case, as a material has a predetermined color and is mixed with pigments that are harmless to a human body, the candle body 6 may have various colors. Accordingly, the candle body 6 may have several shapes and colors.

The decorative combustion material 8 may be shaped in a predetermined size and shape using a material such as the same paraffin wax, bean wax, palm wax, and beeswax as that of the candle body 4.

Further, by adding a pigment and a spice that are harmless to a human body to a raw material of the decorative combustion material 8, the decorative combustion material 8 may have various spices and various colors.

As a pigment that may be added to a raw material of the decorative combustion material 8, for example, a pigment such as light brown, light pink, yellow green, violet, light yellow, khaki, blue, red, gray, brown, blue, and black may be added, and the decorative combustion material 8 may have the same color as that of a pigment due to such a pigment.

As the spice, a natural spice that is extracted and refined from plants or animals or an artificial spice that is made by chemical synthesis may be used, and by mixing such a spice with a material, the decorative combustion material 8 may be shaped.

A spice that may be contained in the decorative combustion material 8 may include, for example, a chamomile incense that helps sound sleep by relieving an anxious and impatient feeling, a lavender incense that is good for relaxation and mind and body rest, a rosemary incense that is good for concentration improvement, a coriander incense or an eucalyptus incense that is good for neuralgia mitigation, a basil incense or a bergamot incense that enhances the mind, a citronella incense that repels insects and mosquitoes, a phytoncide incense that is good for removal of smells of food, a marjoram incense or a melissa incense that is good for insomnia, and a botanica incense that is good for removal of animal smells, and at least one spice that is selected from these spices is contained in the decorative combustion material 8.

Such a decorative combustion material 8 includes a first decorative combustion material 10 that is formed in a piece form and a second decorative combustion material 12 that is formed in a grain form.

The first and second decorative combustion materials 10 and 12 may be produced by mixing the foregoing various pigments and spices in a predetermined ratio in a candle material, and such first and second decorative combustion materials 10 and 12 have several shapes, colors, and scents.

The first decorative combustion material 10 may have a diameter of 0.5 cm to 7 cm and a thickness of 0.2 cm to 10 cm.

If the first decorative combustion material 10 has a diameter of 0.5 cm and a thickness of less than 0.2 cm, the first decorative combustion material 10 is easily broken and it is thus difficult to produce the first decorative combustion material 10, and if the first decorative combustion material 10 has a diameter of 7 cm and a thickness of 10 cm or more, it is difficult to fill the first decorative combustion material 10 in the container 2 due to a very large size and it is difficult to create decoration effects of various forms.

The second decorative combustion material 12 may have a shape of a circle or an oval having a cross-sectional diameter of 0.1 mm to 5 mm.

If the second decorative combustion material 12 has a diameter of less than 0.1 mm, it is difficult to create a decoration effect due to a very small grain, and if the second decorative combustion material 12 has a diameter of greater than or equal to 5 mm, it is difficult to densely fill a space occurring between other first decorative combustion material 10 pieces due to a very large grain.

The first decorative combustion material 10 may be formed in at least one shape that is selected from shapes of an animal, a plant, an insect, a fruit, an object, and fish and shellfish. In this way, when the first decorative combustion material 10 is formed in various shapes, a user selects a desired shape and thus a candle having various shapes can be obtained.

When the user selects a shape, a color, and a scent of the first decorative combustion material 10 and selects a color and a scent of the second decorative combustion material 12, such first and second decorative combustion materials 10 and 12 may be filled within the container 2 while enclosing a periphery of the candle body 6.

Because the first decorative combustion material 10 is formed in a piece form, a gap occurs between the first decorative combustion materials 10, and such a gap may be filled with the second decorative combustion material 12 of a grain form.

Because the decorative combustion material 8 may be randomly selected according to a user's taste and preference, such a candle can satisfy various expectations of each user and provide pleasure when the user directly produces the candle.

That is, because the user can select the container 2, the candle body 6, and the first and second decorative combustion materials 10 and 12, a shape, a color, and a scent of a candle according to the present exemplary embodiment can be variously created.

In this way, when the user selects a shape of the container 2 and the candle body 6, locates the candle body 6 within the container 2, and selects and fills the first and second decorative combustion materials 10 and 12 at a periphery of the candle body 6, the candle body 6 is fixed and supported by the first and second decorative combustion materials 10 and 12.

In this case, the first and second decorative combustion materials 10 and 12 may be formed to represent the same color and scent or may be formed to represent different colors and scents.

Further, the candle body 6 and the first decorative combustion material 10 may be formed to have the same shape and scent, as shown in FIG. 1.

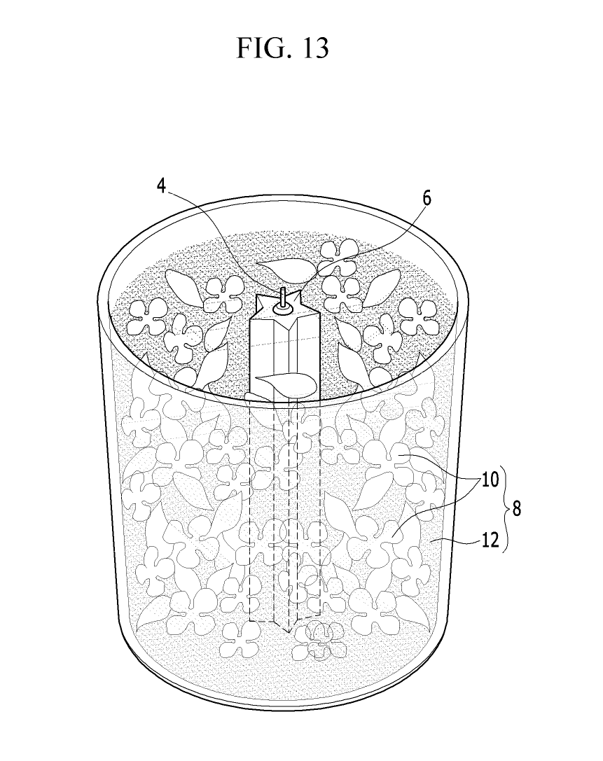

Further, as shown in FIG. 13, while the candle body 6 and the first decorative combustion material 10 are formed in different shapes, the first decorative combustion material 10 is selected in various shapes, colors, and scents and is chaotically filled in the container 2 by mixing various shapes, colors, and scents and the second decorative combustion material 12 is filled between a gap of the first decorative combustion materials, thereby forming a candle.

Further, the first decorative combustion material 10 and the second decorative combustion material 12 having the respective different colors and scents may be sequentially layered in a predetermined thickness.

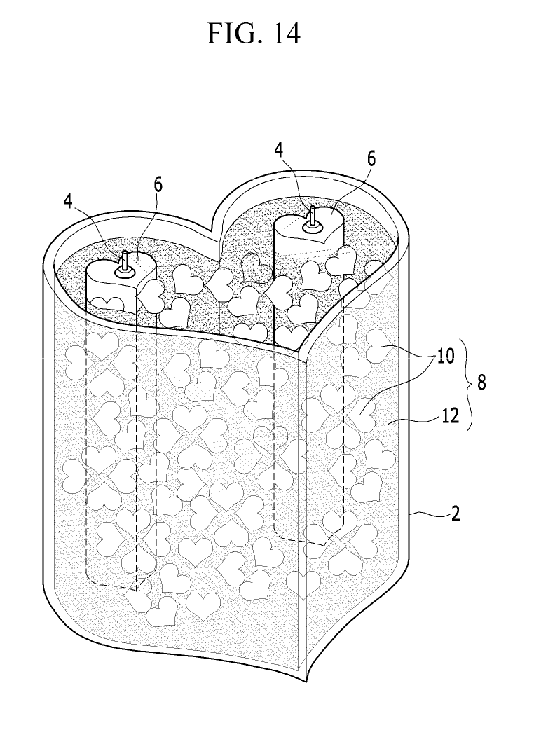

Further, as shown in FIG. 14, a plurality of candle bodies 6 may be formed while maintaining a gap within the container 2, and when the plurality of candle bodies 6 are formed in this way, different atmospheres can be created and a high intensity of illumination can be obtained, compared with when a candle body 6 is formed.

As a user randomly selects a shape, a color, and a scent of the container 2, the candle body 6, and the first decorative combustion material 10 and a color and a scent of the second decorative combustion material 12, a candle may be variously provided according to a user's taste.

When the candle body 6 is received within the container 2 and when the first decorative combustion material 10 and the second decorative combustion material 12 including various colors and spices are filled at a periphery thereof, the candle is formed, and in this case, the user can select a shape and a color of the container 2 and the candle body 6, and a shape and a color of the container 2 and the candle body 6 corresponding to a user's taste may be selected according to a shape and a color of the first and second decorative combustion materials 10 and 12 and a spice that is contained therein.

Such a candle has only one intrinsic shape and scent, and various containers 2 to receive a candle and the first and second decorative combustion materials 10 and 12 including hundreds of kinds of shapes and colors and respective spices are provided at a store, and thus users can directly produce a desired candle, whereby a candle can be obtained, which is a unique candle in the world and is full of character and that a user wants.

When such a candle is displayed at a location, the first and second decorative combustion materials 10 and 12 contain various spices with various colors, and the container 2 is transparently or translucently formed, such that the first and second decorative combustion materials 10 and 12 can be viewed even from the outside of the container 2.

Therefore, when the candle body 6 does not burn, the first and second decorative combustion materials 10 and 12 perform a function of a decoration portion and a function of an air freshener, and thus remarkable visual and olfactory effects can be provided and curiosity and pleasure can be provided to persons around a location of the candle.

Further, when the wick 4 is lit, while the candle body 6 burns, the peripheral first and second decorative combustion materials 10 and 12 burn as well and while colors of the candle body 6 and the first and second decorative combustion materials 10 and 12 are mixed, various colors are created, and spices that are contained in the candle body 6 and the first and second decorative combustion materials 10 and 12 are mixed while each is being diffused, and various scents are discharged to the air.

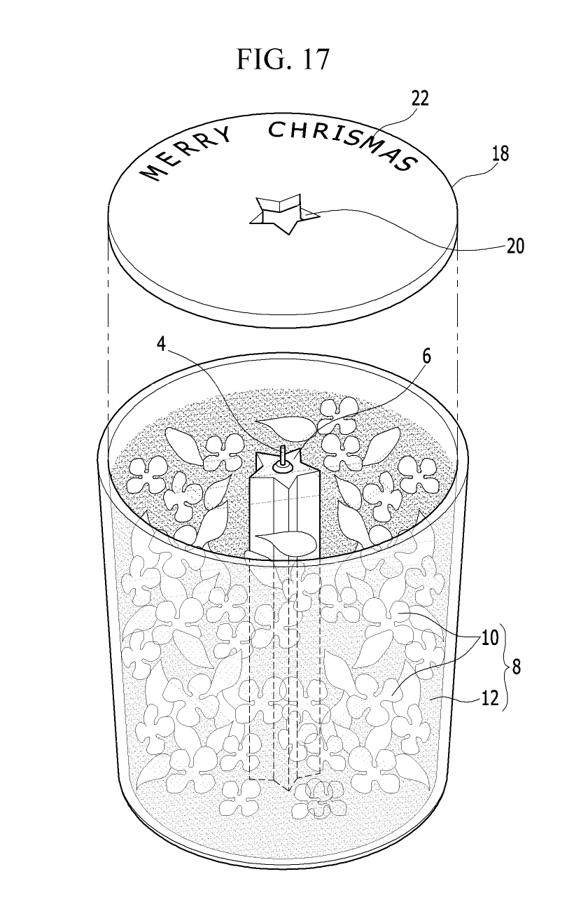

The candle may be used for a gift, and in this case, when the candle is carried, in order for the first and second decorative combustion materials 10 and 12 to be blocked from being discharged to the outside of the container 2, a cover 18 that may be inserted into the container 2 may be provided, as shown in FIG. 17.

In the cover 18, an insertion hole 20 of the same shape as that of the candle body 6 is formed, and when the cover 18 covers the inside of the container 2, while the candle body 6 is inserted into the insertion hole 20, the candle body 6 is covered by the cover 18.

The cover 18 is made of the same combustible material as that of the candle body 6 and the first and second decorative combustion materials 10 and 12.

Further, at a surface of the cover 18, a printing surface 22 is formed, and the printing surface 22 may be printed with various congratulation texts such as “MERRY CHRISTMAS”, HAPPY BIRTHDAY TO YOU”, “I LOVE YOU”, “HAPPY WHITE DAY”, “Congratulations on the first birthday of your baby”, “Congratulations on your 60^{th} birthday, and “Congratulations on your graduation”, and in this case, at the printing surface 22, a name of a congratulation subject may be further printed.

Accordingly, while the cover 18 blocks the first and second decorative combustion materials 10 and 12 from being discharged to the outside of the container 2, when a person who receives the candle and peripheral persons view the printing surface 22, the cover 18 can provide pleasure to the person.

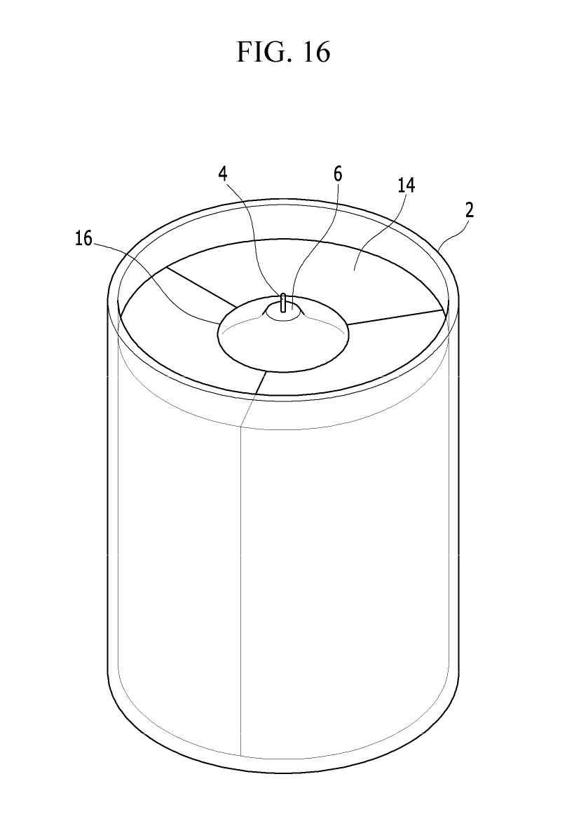

FIGS. 16 and 17 are perspective views illustrating a candle according to a second exemplary embodiment of the present invention, and the second exemplary embodiment of the present invention describes only portions that different from the first exemplary embodiment and portions identical to or corresponding to those of the first exemplary embodiment are substituted for the foregoing portions.

As shown in the drawings, a candle according to a second exemplary embodiment of the present invention is different from that of the first exemplary embodiment in a shape of a decorative combustion material 14.

That is, the decorative combustion material 14 that is provided in a candle of the second exemplary embodiment of the present invention is not formed in a piece and grain form but is formed in a lump form that is divided into at least two in a length direction, and a central portion thereof is formed with a space portion 16 and is housed within a container 2 while enclosing a candle body 6.

An external form of the decorative combustion material 14 and a shape of the space portion 16 have various shapes corresponding to the container 2 and the candle body 6.

In the drawing, the decorative combustion material 14 is divided into three pieces, and each piece is formed in a structure containing different spices with different colors.

In a candle according to a second exemplary embodiment of the present invention, when the candle body 6 does not burn, the decorative combustion material 14 performs a function of a decoration portion and an air freshener, and when the candle body 6 burns, while the decorative combustion material 14 is melted and burned therewith, a color and a shape thereof are mixed to visually enhance an atmosphere, and spices that are each contained in the decorative combustion materials 14 are diffused to the air and thus an olfactory atmosphere is heightened while scents are mixed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A candle comprising:
a container in which an upper portion is an opening portion;
a candle body that is housed within the container and in which a wick is provided; and
a decorative combustion material that is filled within the container while enclosing a periphery of the candle body to perform a function of a decoration portion when the candle body does not burn and that exhibits a visual effect and diffuses a scent while burning when the candle body burns.

2. The candle of claim 1, wherein the container is transparently or translucently formed.

3. The candle of claim 1, wherein a candle body or at least two candle bodies are provided within the container.

4. The candle of claim 1, wherein the container and the candle body have a cross-sectional shape of at least one selected from a circle, a triangle, a quadrangle, a polygon, a heart shape, a star shape, a moon shape, a sun shape, a person shape, a plant shape, and an animal shape.

5. The candle of claim 1, wherein the decorative combustion material comprises a first decorative combustion material that is formed in a piece form and a second decorative combustion material that is formed in a grain form.

6. The candle of claim 5, wherein the first and second decorative combustion materials have several colors.

7. The candle of claim 6, wherein the first and second decorative combustion materials contain a spice.

8. The candle of claim 7, wherein the spice comprises a natural spice or an artificial spice.

9. The candle of claim 5, wherein the first decorative combustion material has a diameter of 0.5 cm to 7 cm and a thickness of 0.2 cm to 10 cm, and the second decorative combustion material has a circular shape or an oval shape having a cross-sectional diameter of 0.1 mm to 5 mm.

10. The candle of claim 8, wherein the spice comprises at least one kind of spice that is selected from chamomile incense, lavender incense, rosemary incense, coriander incense, eucalyptus incense, basil incense, bergamot incense, citronella incense that repels insects and mosquitoes, phytoncide incense, marjoram incense, melissa incense, and botanica spice.

11. The candle of claim 5, wherein the first decorative combustion material has at least one shape that is selected from shapes of an animal, a plant, an insect, a fruit, an object, and fish and shellfish.

12. The candle of claim 1, wherein an upper portion of the decorative combustion material is covered with a cover.

13. The candle of claim 12, wherein the cover can be burned.

14. The candle of claim 12, wherein the cover has an insertion hole that may be inserted into the candle body.

15. The candle of claim 12, wherein the cover has a printing surface.

16. A candle, comprising:
a container in which an upper portion is an opening portion;
a candle body that is received within the container and in which a wick is provided; and
a decorative combustion material that is received within the container while enclosing a periphery of the candle body to perform a function of a decoration portion when the candle body does not burn and that exhibits a visual effect and diffuses a scent while burning when the candle body burns,
wherein the decorative combustion material is divided into at least two in a length direction, and the respective divided decorative combustion materials contain different spices with different colors.

17. A candle, comprising:
a candle body in which a wick is provided; and
a decorative combustion material that is located to enclose a periphery of the candle body to perform a function of a decoration portion when the candle body does not burn and that exhibits a visual effect and diffuses a scent while burning when the candle body burns,
wherein the decorative combustion material is divided into at least two in a length direction, and the respective divided decorative combustion materials contain different spices with different colors.

18. A method of assembling a candle, the method comprising:
selecting a container in which an upper portion is an opening portion and that has a predetermined shape;
selecting a candle body in which a wick is provided and that contains a predetermined spice while having a predetermined color and shape;
receiving the selected candle body within the container;
selecting a decorative combustion material that contains a predetermined spice while having a predetermined color and shape; and
fixing the candle body by filling the selected decorative combustion material within the container.
